(19) United States
(12) Patent Application Publication
(10) Pub. No.: US 2002/0006454 A1
(43) Pub. Date: Jan. 17, 2002

(54) Mold ejection apparatus for use in compression molding of cellulosic articles

(76) Inventors: Jay Machael, Muscatine, IA (US); Anthony Joseph Cline, Muscatine, IA (US); Dallas Scott Calvegage, Muscatine, IA (US); Christopher Patrick Schrauth, Wabasha, MN (US); Shannon Paul, Fruitland, IA (US)

Correspondence Address: Ronald A. Sandler, Jones, Day, Reavis & Pogue, 77 West Wacker Drive, Chicago, IL, 60601-1692, US

(21) Appl. No.: 09/802,220

(22) Filed: Mar. 8, 2001

Related U.S. Application Data
(60) Provisional application No. 60/188,467, filed on Mar. 10, 2000.

(51) Int. Cl. B29C 43/50

(52) U.S. Cl. 425/444

(57) ABSTRACT

An ejection system for use with a compression molding apparatus includes one or more molds each having a core member and a cavity member, wherein the core member is provided with spring biased knock-out pins that are engaged by a cross member to extend the pins and release a molded article when the mold is in an open position.

### CROSS REFERENCE TO RELATED APPLICATION

Priority is claimed from U.S. Provisional Application Ser. No. 60/188,467, filed Mar. 10, 2000.

### BACKGROUND OF THE INVENTION

1. Field of the Invention

The present invention relates generally to mold ejection apparatus for use in compression molding of cellulosic articles and, more particularly, to the molding under heat and pressure of thermosetting resin coated wood fiber furnish which has been recycled from waste wood articles and convenient ejection of the molded article from the mold.

2. Description of the Related Art

It has long been known that synthetic products can be manufactured using a thermosetting binder, heat and pressure to reconsolidate refined cellulosic and/or lignocellulosic furnish materials into unitary rigid products. One common form of such products is particle board or fiberboard. The binders usually used in producing particle board, for example, are thermosetting resins such as urea-formaldehyde or phenol-formaldehyde. An example of a process for manufacturing such boards is disclosed in early U.S. Pat. No. 2,757,115 issued to Heritage. Basically, this patent teaches reducing a furnish material, such as wood, to fibers by a refiner, mixing the fibers with a binder and other chemicals such as release and sizing agents, forming the mixture into mats and compressing the mats between heated platens in a hot press to form board products of a desired thickness and density.

Waste disposal is an ever increasing concern to society. Although recycling efforts have been relatively successful with a variety of materials, certain materials have continually posed a problem as being generally non-recyclable. Examples of these hard-to-recycle materials include urban wood waste such as demolition waste from old buildings, wood chips generated from construction materials, old pallets and crates and the like. Accordingly, it is desirable to provide a process for recycling urban wood waste into useful synthetic wood-base products. Further, it is desirable to provide such a process which can produce molded articles under heat and pressure in various shapes and contours, such as, for example, chair form products for manufacturing chair seats and backs. Still further, it is desirable to provide a highly effective means for ejecting a molded article from its mold.

### SUMMARY OF THE INVENTION

The present invention improves over the prior art by providing an ejection system for use with a compression molding apparatus including one or more molds each having a core member and a cavity member, wherein the core member is provided with spring biased knockout pins that are engaged by a cross member to extend the pins and release a molded article when the mold is in an open position.

### BRIEF DESCRIPTION OF THE DRAWING

The foregoing and other novel improvements and advantages of the invention will be better understood upon a reading of the following detailed description taken in conjunction with the accompanying drawing wherein:

FIG. 1 is a side schematic view of a compression molding apparatus illustrating an article ejection system constructed according to the principles of the invention.

### DETAILED DESCRIPTION OF THE PREFERRED EMBODIMENTS

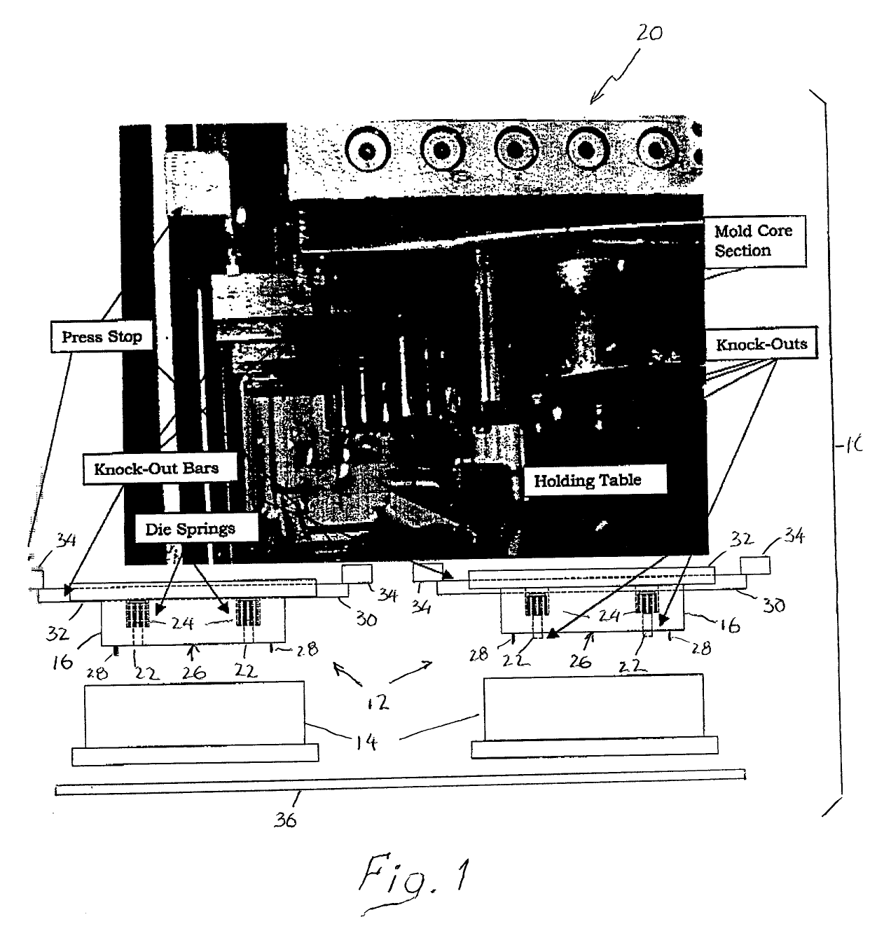

Referring now to the drawing, FIG. 1 illustrates a side schematic view of a dual mold compression molding apparatus designated generally by the reference numeral 10. The apparatus 10 is particularly suitable for compression molding under heat and pressure, of recycled wood waste which has been ground into fibers of predetermined dimensions and mixed with a binder such as a thermosetting resin. Batches of mixed fibers and resin are delivered by any convenient means to one or more two-part molds 12 including mold cavity members 14 and mold core members 16. The mold core members 16 are suspended from a suitable hydraulic cylinder press apparatus designated generally as 20. Preferably, the molds 12 are heated to an appropriate elevated temperature by circulating hot oil through internal mold passages.

Each mold core member 16 and cavity member 14 may be designed to compress the wood fiber and resin composition into any suitable finished shape. An example of a molded article may be a formed chair seat or chair back having suitable contour such that it can be later upholstered to provide a comfortable chair product. Once the cavity member 14 is loaded with a batch of fiber and resin, the mold 12 closes and by heat and pressure the fibers are compressed into a dense mass. The resin is then allowed to cure.

Fitted in the core member 16 are a plurality of knock-out pins 22 which are biased by springs 24 such that the distal ends of the pins 22 are flush with the lower surface 26 of the core member 16 when the press is closed. After curing of the resin the molds 12 are opened to an intermediate position whereupon the molded article is removed from the cavity members 14 by adhering to downwardly directed pins 28 projecting from the core surface 26. The cavity member 14 is then shuttled to the side. In accordance with the invention, a cross member 30 is located above the pins 22 in a mounting plate 32 on top of the core member 14. As the mold 12 is further opened the cross member 30 strikes one or more stops 34 which causes the cross member to engage proximal ends of the pins 22 and extend the pins 22, against the action of the springs, beyond the surface 26 of the core member 16 thereby urging the molded article to dislodge from the pins 28 and separate from the core member 16. The molded article then drops onto a table 36 whereupon it can be removed by any convenient means.

It can now be appreciated that the ejection system of the present invention provides a highly effective and efficient means of ejecting a molded article from a press. Particularly where heated molds are employed the ejection system of the present invention is considerably effective, as opposed to prior art ejection means, in reducing undesirable heat transfer from the molds.

While the present invention has been described in connection with preferred embodiments thereof, it will be apparent to those skilled in the art that many changes and modifications may be made without departing from the true spirit and scope of the invention. Accordingly, it is intended by the appended claims to cover all such changes and modifications as come within the spirit and scope of the invention.

What is claimed is:

1. An ejection system for use with compression molding apparatus including one or more molds each having a core member and a cavity member comprising:
a plurality of knock-out pins fitted in said core member;
a cross member configured to engage said pins when said mold is in an open position;
a plurality of stops engageable by said cross member to cause said cross member to engage ends of said pins and extend said pins into engagement with an article molded in said mold to dislodge said article from said core member.

2. The system of claim 1 wherein said pins are spring biased.
